(19) United States
(12) Patent Application Publication
(10) Pub. No.: US 2018/0237099 A1
(43) Pub. Date: Aug. 23, 2018

(54) SMART BICYCLE

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventors: Ze LIU, Beijing (CN); Pengcheng TIAN, Beijing (CN); Xin LI, Beijing (CN)

(21) Appl. No.: 15/558,204

(22) PCT Filed: Jan. 13, 2017
(86) PCT No.: PCT/CN2017/071087

§ 371 Date: Sep. 14, 2017

(30) Foreign Application Priority Data
Jun. 13, 2016 (CN) 201610409821.X

(51) Int. Cl. B62K 21/16; B62J 1/06; B62J 6/00; B62J 99/00

(52) U.S. Cl. CPC B62K 21/16; B62J 1/06; B62J 6/003; B62K 2208/00; B62J 2099/0013; B62J 2099/0033; B62J 2099/004; B62J 99/00

(57) ABSTRACT

A smart bicycle is disclosed, which includes a battery module, a controller connected to the battery module, and a linkage device that is configured to electrically adjust the height of the saddle and/or the handlebar under the control of the controller. The smart bicycle effectively overcomes the inconvenience of manually adjusting the height of the saddle and/or the handlebar, improves comfort for riders of different body types, and enhances safety during riding.

### RELATED APPLICATION

The present application is the U.S. national phase entry of PCT/CN2017/071087, with an international filing date of Jan. 13, 2017, which claims the benefit of Chinese Patent Application No. 201610409821.X, filed on Jun. 13, 2016, the entire disclosures of which are incorporated herein by reference.

### TECHNICAL FIELD

The present disclosure relates to the field of intelligent life, in particular to a smart bicycle.

### BACKGROUND

Bicycles are important means of transportation in people's daily life, and are also widely used in outdoor activities by sports enthusiast. But existing bicycles lack intelligence, because the heights of the saddle and the handlebar of the bicycle can only be manually adjusted. When it is necessary to adjust the height of the saddle or the handlebar of the bicycle during riding, the bicycle has to be stopped; otherwise it will cause serious security risks.

### SUMMARY

According to one aspect of the present disclosure, a smart bicycle is provided, which comprises a battery module, a controller connected to the battery module, and a linkage device that is configured to electrically adjust the height of the saddle and/or the handlebar under the control of the controller.

This is advantageous because a rider can adjust the height of the saddle and/or the handlebar during riding without the need to stop the bicycle to adjust manually, thus the inconvenience of manual adjustment is effectively overcome and comfort for riders of different body types is improved.

In certain exemplary embodiments, said linkage device may comprise a first linkage device and/or a second linkage device, said first linkage device is arranged in a seat tube of the smart bicycle and is configured to electrically adjust the height of the saddle under the control of the controller, and said second linkage device is arranged in a head tube of the smart bicycle and is configured to electrically adjust the height of the handlebar under the control of the controller.

In certain exemplary embodiments, said smart bicycle further comprises a bicycle light and a bicycle light controller that is configured to control the bicycle light under the control of the controller.

Said control may include control of the brightness, color, etc. of the bicycle light.

In certain exemplary embodiments, said controller further comprises a display device through which a user can operate said controller.

This is advantageous because the user can interact with the controller more intuitively, thereby realizing the control function more easily.

In certain exemplary embodiments, said smart bicycle further comprises a GPS navigator, and said display device is configured to display navigation data of the GPS navigator. Said navigation data may, for example, be map data. A rider can use said navigator to realize such functions as “positioning”, “destination selecting”, “route calculating” and “route guiding”. This is advantageous because riding of the rider is facilitated

In certain exemplary embodiments, said smart bicycle further comprises a Bluetooth module, and said display device is configured to display data received by the Bluetooth module.

This is advantageous because the display device can display any data received by the Bluetooth module from external devices. For example, the display device can display image data and video data received from a mobile phone, for example, so that the riding becomes less boring for the rider; or the display device can display such data as heart rate received from a smart wristband or a smart bracelet, etc., so that the rider can learn about his/her physical condition more accurately. These can help to improve safety of the riding, because the rider can be in a better mood or learn about his/her physical condition in real time by viewing the display device, thereby avoiding fatigue riding as much as possible.

In certain exemplary embodiments, said display device can be arranged on an upper tube or the handlebar of the bicycle. This is advantageous because such an arrangement can facilitate the rider to see the contents displayed on the display device more intuitively.

In certain exemplary embodiments, said display device may comprise a display screen which is configured to automatically adjust the display brightness according to the brightness of ambient light. For example, when the bright of ambient light is higher, the display screen can reduce the display brightness, and when the bright of ambient light is lower, the display screen can increase the display brightness. Additionally, said display screen can be an antiglare display screen. This is advantageous because it enables the rider to see clearly the contents displayed on the display screen even in the sunlight, thereby avoiding risks in the riding because of failing to see clearly the contents (e.g. navigation data) displayed on the display screen.

In certain exemplary embodiments, said battery module is a rechargeable battery. In this case, said smart bicycle may also comprise a power generating device for charging the battery module during rotation of a wheel.

This is advantageous because the energy consumed during rotation of the wheel can be collected and reused.

In certain exemplary embodiments, said power generating device may comprise an electromagnetic induction circuit. This is advantageous because it is efficient to generate power by means of electromagnetic induction.

In certain exemplary embodiments, said power generating device is arranged at a wheel axle of a wheel of the smart bicycle. This is advantageous because the power generation efficiency can be greatly improved by arranging the power generating device, especially the electromagnetic induction circuit, at the wheel axle.

These and other advantages of the present disclosure will be apparent from the embodiments described below, and these and other advantages of the present disclosure will be illustrated with reference to the embodiments described below.

### BRIEF DESCRIPTION OF THE DRAWINGS

Embodiments of the present disclosure will be described in further detail with reference to the drawings, in which

FIG. 1 is an exemplary structural block diagram of a smart bicycle according to an embodiment of the present disclosure;

FIG. 2 is a schematic drawing of a smart bicycle according to an embodiment of the present disclosure;

FIG. 3 is an exemplary structural diagram of a linkage device of a smart bicycle according to an embodiment of the present disclosure;

FIG. 4 is an exemplary structural diagram of a power generating device of a smart bicycle according to an embodiment of the present disclosure.

### DETAILED DESCRIPTION

The descriptions below provide specific details for fully understanding and enabling various embodiments of the present disclosure. Those skilled in the art shall understand that the technical solution of the present disclosure can be implemented without many of these details. In some cases, known structures or functions are not shown or described in detail to avoid unnecessarily blurring descriptions of the embodiments of the present disclosure. It shall be anticipated that terms used herein are interpreted in the broadest reasonable manner, even if they are used in combination with detailed descriptions of the specific embodiments of the present disclosure. For example, the term “based on or in response to” is not exclusive and is equivalent to the term of “at least partially based on or in response to”, and includes based on some additional factors not described herein.

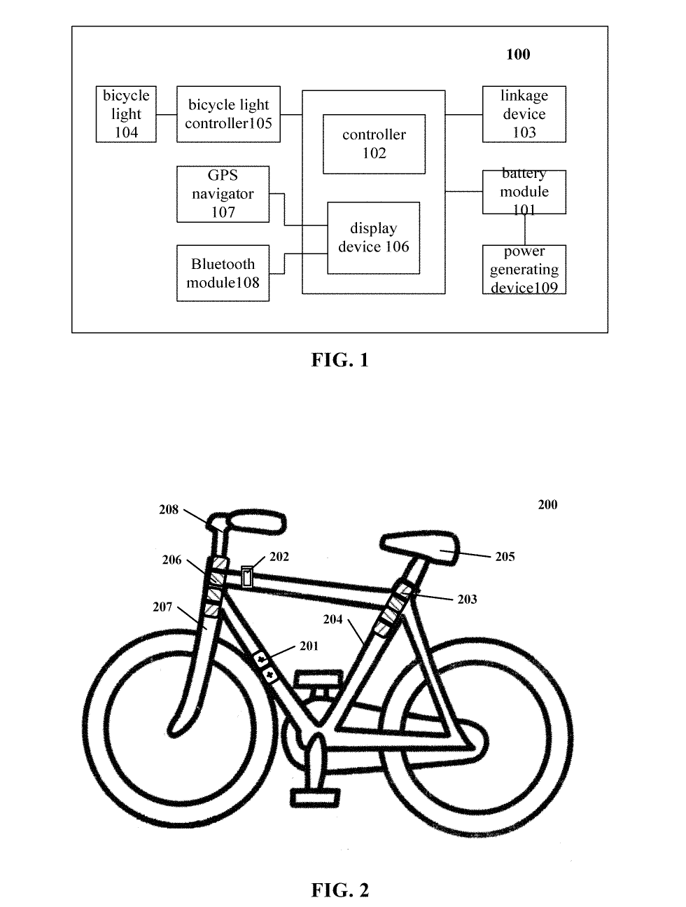

FIG. 1 is an exemplary structural block diagram of a smart bicycle according to an embodiment of the present disclosure. As shown in the figure, said smart bicycle 100 comprises a battery module 101 and a controller 102 connected to the battery module. Said smart bicycle further comprises a linkage device 103 configured to electrically adjust the height of the saddle and/or the handlebar of the smart bicycle under the control of the controller.

In some embodiments, said smart bicycle may further comprise a bicycle light 104 and a bicycle light controller 105 that is configured to control the bicycle light under the control of the controller. Said control may include control of the brightness, color, etc. of the bicycle light, which is not limited herein. Said bicycle light can, for example, be configured to illuminate the road or be configured to send alarm signals, for example, by means of light of different colors (especially at night).

In some embodiments, said controller 102 may comprise a display device 106 through which the rider can operate said controller. Said display device can be integrated onto the controller 102 as a whole (as shown in FIG. 1), or it can be physically separated from the controller.

As an example, said display device may comprise a display screen (not shown) configured to automatically adjust the display brightness according to the brightness of ambient light. For example, when the brightness of ambient light is higher, the display screen can reduce the display brightness, and when the brightness of ambient light is lower, the display screen can increase the display brightness. For example, when riding the bicycle in a cave or a tunnel, the display screen may increase the display brightness so that the rider can see the contents displayed on the display screen. Additionally, said display screen can be an antiglare display screen, so that the display screen can be seen clearly even in the sunny open air.

As an example, said display device can be arranged on an upper tube or the handlebar of the bicycle so as to facilitate the rider to see the contents displayed on the display device more directly.

As an example, said smart bicycle may further comprise a GPS navigator 107, and said display device is configured to display navigation data of the GPS navigator. Said navigation data may, for example, be map data. The rider can use said navigator to realize such functions as “positioning”, “destination selecting”, “route calculating” and “route guiding”. Additionally, said display device may further comprise a voice module configured to play navigation data of the navigator by voice.

As another example, said smart bicycle may further comprise a Bluetooth module 108, and said display device is configured to display data received by the Bluetooth module. Said data can be any data received by the Bluetooth module from external devices, such as image data and video data received from a mobile phone, data like heart rate received from a smart wristband or a smart bracelet, and so on.

Said battery module 101 can be any component capable of supplying power, such as a rechargeable battery. Said smart bicycle may further comprise a power generating device 109 that can be configured to generate power during rotation of the wheel and to charge the rechargeable battery. For example, said power generating device may comprise an electromagnetic induction circuit, which generates power by means of electromagnetic induction principle and charges the rechargeable battery. It shall be noted that other power generating devices are also contemplated, for example, a device of friction electrification is used, which generates power by means of the friction with the wheels or the tires during rotation of the wheels. In an embodiment, the power generating device can be arranged at the wheel axle of the wheel of the smart bicycle. Such an arrangement is only made out for the sake of power generation efficiency, and indeed the power generating device may also be arranged at other positions, which is not limited.

FIG. 2 is a schematic drawing of a smart bicycle 200 according to an embodiment of the present disclosure. As shown in the figure, said smart bicycle 200 comprises a battery module 201 and a controller 202. As described above with reference to FIG. 1, said smart bicycle may further comprise a linkage device. In FIG. 2, said smart bicycle is shown as comprising a first linkage device 203 and a second linkage device 206. It shall be noted that not both the first linkage device and the second linkage device are required to be present on the smart bicycle, and it is possible that only one of them is present.

As shown in FIG. 2, the first linkage device 203 is arranged in a seat tube 204 of the smart bicycle and is configured to electrically adjust the height of a saddle 205 under the control of the controller 202. The second linkage device 206 is arranged in a head tube 207 and is configured to adjust the height of the handlebar 208 under the control of the controller. Said smart bicycle may further comprise some other devices or components to improve comfort and safety for the rider, as described above.

The battery module 201 may be in any position of the smart bicycle. But for portability considerations, it may be arranged in a lower tube of the smart bicycle, as shown in FIG. 2. The controller 202 can be arranged on the handlebar or on the upper tube (as shown in FIG. 2) so as to be operated by the rider during riding.

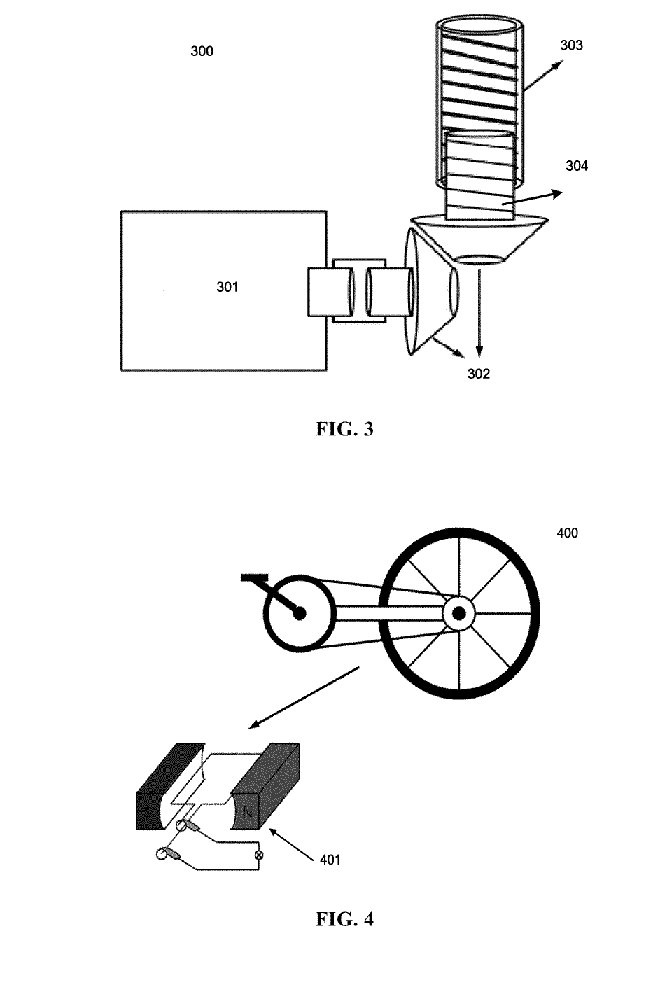

FIG. 3 is an exemplary structural diagram of a linkage device 300 of a smart bicycle according to an embodiment of the present disclosure. As shown in the figure, said linkage device 300 comprises a motor 301, a gear 203, a screw sleeve 303 and a screw 304. Said screw sleeve is connected to the saddle or the handlebar of the smart bicycle. Said screw can be connected to the gear. Said motor can drive the screw sleeve to rotate via the gear when it is power on. For example, forward and reverse rotations of the gear are enabled by forward and reverse rotations of the motor, and forward and reverse rotations of the gear can enable forward and reverse rotations of the screw. In this way, the forward and reverse rotations of the screw can further drive forward and reverse rotations of the screw sleeve that is arranged in line with the saddle or the handlebar, so that the saddle or the handlebar can be moved up and down to adjust the saddle height. The power-on and forward or reverse rotation of the motor can be controlled by the controller as described with reference to FIG. 1 or FIG. 2.

It shall be noted that the linkage device 300 is merely an example. The linkage device may have other structures. For example, in the linkage device shown in FIG. 3, there may be two screw sleeves and screws, said two screw sleeves are respectively connected to the saddle and the handlebar so as to drive both the saddle and the handlebar simultaneously by one motor 301. For example, the motor may directly drive the screw without using the gear drive. In the present disclosure, the use of the gear makes the arrangement of the motor more flexible, thus facilitating arrangement of the motor in the not-wide-enough space of the bicycle. Moreover, a pneumatic linkage device or a hydraulic linkage device may be used.

FIG. 4 is an exemplary structural diagram of a power generating device 400 of a smart bicycle according to an embodiment of the present disclosure. Said power generating device is configured to charge the battery module during rotation of a wheel. Said wheel can be a front wheel or a back wheel of the bicycle. As shown in FIG. 4, said power generating device comprises an electromagnetic induction circuit 401, which can, for example, be arranged at a wheel axle of a wheel of the smart bicycle (show to be the back wheel in FIG. 4), so that electric current is generated during rotation of the wheel to charge the battery module. Of course, other electronic devices, such as a mobile phone, may also be charged. It shall be noted that said power generating device 400 is merely an example, while other power generating devices are also contemplated, such as a power generating device with friction electrification as mentioned above.

It shall be understood that for the sake of clarity, embodiments of the present disclosure are described with reference to different functional units. But it is apparent that the functionality of each functional unit can be implemented in a single unit, in multiple units or be implemented as a part of other functional units without departing from the disclosure of the present disclosure. For example, a functionality described as being implemented by a single unit can be implemented by a plurality of different units. Therefore, reference to a specific functional unit is only considered as reference to a proper unit for providing the described functionality, but it does not indicate any strict logic or physical structure or organization. Therefore, the present disclosure can be implemented in a single unit, or it can be distributed between different units and circuits physically and functionally.

Although the present disclosure has been described with reference to some embodiments, the disclosure is not limited to the specific forms described. On the contrary, the scope of the present disclosure is only defined by the appended claims. Additionally, individual features can be included in different claims, but said features can be combined to advantage, and said features being included in different claims does not mean that combination thereof is unfeasible and/or unfavorable. The sequence of the features in the claims does not imply any specific order in which the features must work. In addition, in the claims, the word “comprise” does not exclude other elements, and the indefinite article “a” or “an” does not exclude a plurality. Reference signs used in the claims are merely provided as explicit examples, but they should not be construed as limiting the scope of the claims in any way.

1. A smart bicycle, comprising:
a battery module;
a controller connected to the battery module; and
a linkage device that is configured to electrically adjust the height of at least one of the saddle and the handlebar under the control of the controller.

2. The smart bicycle according to claim 1, wherein the linkage device comprises a first linkage device, the first linkage device is arranged in a seat tube of the smart bicycle and is configured to electrically adjust the height of the saddle under the control of the controller.

3. The smart bicycle according to claim 1, further comprising a bicycle light and a bicycle light controller that is configured to control the bicycle light under the control of the controller.

4. The smart bicycle according to claim 1, wherein the controller further comprises a display device through which a user operates the controller.

5. The smart bicycle according to claim 4, wherein the display device is arranged on an upper tube of the bicycle.

6. The smart bicycle according to claim 4, wherein the smart bicycle further comprises a GPS navigator, and the display device is configured to display navigation data of the GPS navigator.

7. The smart bicycle according to claim 4, wherein the smart bicycle further comprises a Bluetooth module, and the display device is configured to display data received by the Bluetooth module.

8. The smart bicycle according to claim 1, wherein the battery module is a rechargeable battery.

9. The smart bicycle according to claim 8, further comprising a power generating device for charging the battery module during rotation of a wheel.

10. The smart bicycle according to claim 9, wherein the power generating device comprises an electromagnetic induction circuit.

11. The smart bicycle according to claim 9, wherein the power generating device is arranged at a wheel axle of a wheel of the smart bicycle.

12. The smart bicycle according to claim 1, wherein the linkage device comprises a second linkage device, the second linkage device is arranged in a head tube of the smart bicycle and is configured to electrically adjust the height of the handlebar under the control of the controller.

13. The smart bicycle according to claim 10, wherein the power generating device is arranged at a wheel axle of a wheel of the smart bicycle.

14. The smart bicycle according to claim 4, wherein the display device is arranged on the handlebar of the bicycle.

15. The smart bicycle according to claim 4, wherein the display device comprises a display screen which is configured to automatically adjust the display brightness according to the brightness of ambient light.

16. The smart bicycle according to claim 6, wherein the display device comprises a voice module configured to play navigation data of the navigator by voice.

17. The smart bicycle according to claim 15, wherein display screen comprises an antiglare display screen.
